(19) United States
(12) Patent Application Publication
(10) Pub. No.: US 2018/0158347 A1
(43) Pub. Date: Jun. 7, 2018

(54) Educational Proficiency Development and Assessment System

(71) Applicant: Protean LLC, Montpelier, VT (US)

(72) Inventors: Ali Sarafzade, Burlington, VT (US); Penny Bishop, Morrisville, VT (US); James Nagle, Montpelier, VT (US); Gary Tilden, South Burlington, VT (US); Mark Oettinger, Burlington, VT (US)

(21) Appl. No.: 15/580,198

(22) PCT Filed: Nov. 18, 2015
(86) PCT No.: PCT/US15/61435

§ 371 Date: Dec. 6, 2017

Related U.S. Application Data
(60) Provisional application No. 62/172,105, filed on Jun. 7, 2015.
(60) Provisional application No. 62/245,064, filed on Oct. 22, 2015.

(51) Int. Cl. G09B 5/00; G06Q 10/10; H04W 4/02

(52) U.S. Cl. CPC G09B 5/00; G06Q 50/01; H04W 4/02; G06Q 10/109

(57) ABSTRACT

A system for developing, aggregating, tracking and reporting individual achievement to create individualized learning plans and proficiency metrics using real time inputs from various learning tools, such as, but not limited to, social media, the individual user, teachers, parents, schools, or any number of other stakeholders in the educational process or those needing an evaluative measure of an individual's proficiency as it relates to certain skills is disclosed. The system can receive varied inputs from an individual's learning environment, such as, but not limited to, inside the classroom, outside the classroom, third party online learning tools, and the individual's immediate environment, to aggregate, dynamically populate, track, and report against an individual learning plan. In certain embodiments, the EPD can use geolocation and filters, specifically related to the individual's learning plan, to identify and present relevant learning opportunities for the individual to engage in.

### RELATED APPLICATIONS

This application claims the benefit of U.S. Provisional Application No. 61/622,301, filed Apr. 10, 2015, and titled “Systems and Methods for the Development of Automated Online & Individualized Learning Plans and Performance Aggregation For K16 Students”, and U.S. Provisional Application No. 62/245,064, filed on Oct. 22, 2015, and titled “Educational Proficiency Development and Assessment System”, each of which is hereby incorporated by reference herein in its entirety.

### FIELD OF THE INVENTION

The present invention generally relates to learning plan development systems. In particular, the present invention is directed to an Educational Proficiency Development and Assessment System.

### BACKGROUND

Students and other individuals that look to enhance their skills in a certain subject area or discipline are hoping to gain or obtain proficiency at that given subject area or discipline. This traditional “skill building” or “content knowledge” model has been done primarily in a classroom environment so that a student's improvement can be credited, i.e., acknowledged for being a participant and completing the exercise, and/or measured through testing and the like. However, this traditional content knowledge program has significant drawbacks for the individual enrolled in the class, the evaluator/teacher, and an employer/admissions type reviewer because the actual proficiency obtained is often poorly reflected by the individual's mere completion of a course or the grade obtained.

Take, for example, a traditional course such as algebra. This course may introduce algebraic concepts and provide for instruction and evaluation of students taking the class. The following term a student may take algebra II, which may cover the same topics as the previous algebra course but provide more difficult problems and more intricate problems to build and develop new concepts for students to master in the field of algebraic mathematics. Eventually the student would typically be evaluated by tests related to the lessons, a semester of material, and cumulatively, through state-wide achievement tests, or such tests as the “SAT,” “ACT,” and Advanced Placement (“AP”) tests. At the end of the course or unit, the student will have either passed or failed the course and receive a grade that is supposed to reflect the student's mastery of the algebraic material.

As is evident, the traditional content knowledge model does little to provide students with actual real world skills nor does it track the development of those knowledge or skills gained. Because the emphasis is on learning course content, students generally do not demonstrate the ability to apply the course content in a non-academic or cross-disciplined setting or from activities associated with informal learning, such as an after-school project, work-study, internship, or competition. Indeed, often no heed is given at all to applying the underlying processes to demonstrate through a project based, experiential exercise.

A more problematic issue is that the grade earned by the student does not offer an indication of the student's proficiency, which is a measure of competency in the discipline. In other words, while a student may have earned a high grade, her “success” may be attributed to any number of factors, including, but not limited to, the type of test given (e.g., multiple choice vs. word problems), the concepts covered by the testing (i.e., a focus on only certain topics), grade manipulation (e.g., the class “curve”), etc.

By masking the proficiency of a student, the traditional content knowledge model fails to identify individuals that have gaps in their underlying knowledge base. For example, a person who has “excelled” at algebra, may have difficulties with dealing with fractions—traditional testing would not expose this deficiency. Importantly, an outside observer, e.g., a teacher or parent, may not be aware that the student is more likely to struggle with future mathematical concepts due to this deficiency.

Another issue with the traditional content knowledge model is that there is a failure to account for outside-of-classroom learning in evaluating proficiency in a particular skill. Indeed, educational programs are trending toward a narrowing of non “common core” skills and knowledge by focusing on “common core” topics. This trend leaves out training in certain skills, knowledge, and dispositions (collectively referred to herein as a “skill” or “skills”), and student experiences with alternative or non-traditional exercises. Moreover, because testing focuses on the “common core” standards, it diminishes the ability to truly assess the student's proficiency beyond those common core areas or the impact of learnings from informal learning environments, such as a competition, an enterprise such as “Khan Academy”, or an online course.

It is known that individuals gain proficiencies in a myriad of different contexts and through different means. A traditional content knowledge model that is focused on the classroom environment fails to account for these experiences and how they relate practically to the proficiency of the individual in a certain skill. Tracking external/alternative learnings is a first step, but that alone will not allow for an assessment of proficiency—allowing an individual to “check a box” for completion is akin to a certificate of completion, which may give an evaluator an indication of something (e.g., student interest, attendance, etc.), but likely not an indication of proficiency. What is needed is a proficiency development system that accounts for all types of learning and provides an assessment of an individual's proficiency based upon the learning of those skills.

### SUMMARY OF THE DISCLOSURE

In an exemplary aspect, a computer-implemented method is disclosed, the computer-implemented method comprising by one or more computing devices: receiving an activity associated with a user goal, wherein the user goal has a proficiency metric; evaluating the relevancy of the activity, the relevancy being a function of the timing of the activity and the relationship of the activity to the one or more user goals; and developing an updated proficiency metric based upon the evaluating.

In another exemplary aspect, an educational proficiency development (EPD) system for a user, the EPD system comprising: a portable device having a processor and a non-transitory computer readable medium in communication with the processor, wherein the non-transitory computer readable medium includes: an input module configured to: determine a location of the portable device and an activity related to the location, wherein the activity relates to a user goal; and receive data representing one or more artifacts that are related to the activity; and a relevancy module configured to determine a user's progress toward a proficiency of the user goal based upon the activity and the one or more artifacts.

In yet another exemplary aspect, one or more computer-readable non-transitory storage media embodying software configured when executed to: receive an activity associated with a user goal, wherein the user goal has a proficiency metric, wherein the proficiency metric is a quantifier of user competency as the competency relates to the user goal; evaluate the relevancy of the activity, the relevancy being a function of the timing of the activity and the relationship of the activity to the one or more user goals; aggregate the activity into a user timeline, the user timeline including a prior event; develop an updated proficiency metric based upon the evaluating.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic representation of an information system for use with an educational proficiency development system (EPD) according to an embodiment of the present invention;

FIG. 2 is a block diagram of an exemplary EPD according to an embodiment of the present invention;

FIG. 3 is a process diagram of an exemplary process of inputting information into an EPD according to an embodiment of the present invention;

FIG. 4 is a diagram of an exemplary timeline of an individual's experiences according to an embodiment of the present invention;

FIG. 5 is a diagram of an exemplary dynamic resume for an individual according to an embodiment of the present invention;

FIG. 6 is a process diagram of an exemplary process of developing a proficiency metric according to an embodiment of the present invention;

FIG. 7 is a process diagram of exemplary process of developing a class according to an embodiment of the present invention;

FIGS. 8A-C are schematics of a mobile device for use with an EPD according to an embodiment of the present invention;

FIG. 9 is an exemplary individual profile developed as part of an EPD according to an embodiment of the present invention; and

FIG. 10 is a schematic representation of a computer system suitable for use with the EPD according to an embodiment of the present invention.

### DESCRIPTION OF THE DISCLOSURE

An educational proficiency development (EPD) system of the present disclosure relates to the field of online education management and more particularly to developing, aggregating, tracking and reporting individual achievement to create individualized learning plans and proficiency metrics using real time inputs from various learning tools, such as, but not limited to social media, the individual user, teachers, parents, schools, or any number of other stakeholders in the educational process or those needing an evaluative measure of an individual's proficiency as it relates to certain skills. The EPD can receive varied inputs from an individual's learning environment, such as, but not limited to, inside the classroom, outside the classroom, third party online learning tools, and the individual's immediate environment, to aggregate, dynamically populate, track and report against an individual learning plan. In certain embodiments, the EPD can use geolocation and filters, specifically related to the individual's learning plan, to identify and present relevant learning opportunities for the individual to engage in. The individual learning plan and each of the individual's inputs are then reportable and searchable and can be organized in the form of a dynamic living resume of the individual's achievements against which a marketplace can search, identify and prepopulate offers and opportunities to the individual's or in some instances an entity's (e.g., the individual's class or district or employer) unique profile and achievements.

The EPD system can, in certain embodiments, result in a dynamic resume of the individual's life achievements, areas in need of improvement, and proficiency metrics that are searchable and reportable to stakeholders based on the individuals scholastic profile and individual learning plan. The EPD can also track an individual's progress toward goals that have been input or suggested by the individual or a third-party (e.g., teacher, state board, school district, employer, etc.) The EPD can identify appropriate opportunities from within an online marketplace specifically matched to the individual's unique profile that is supported by the dynamic resume.

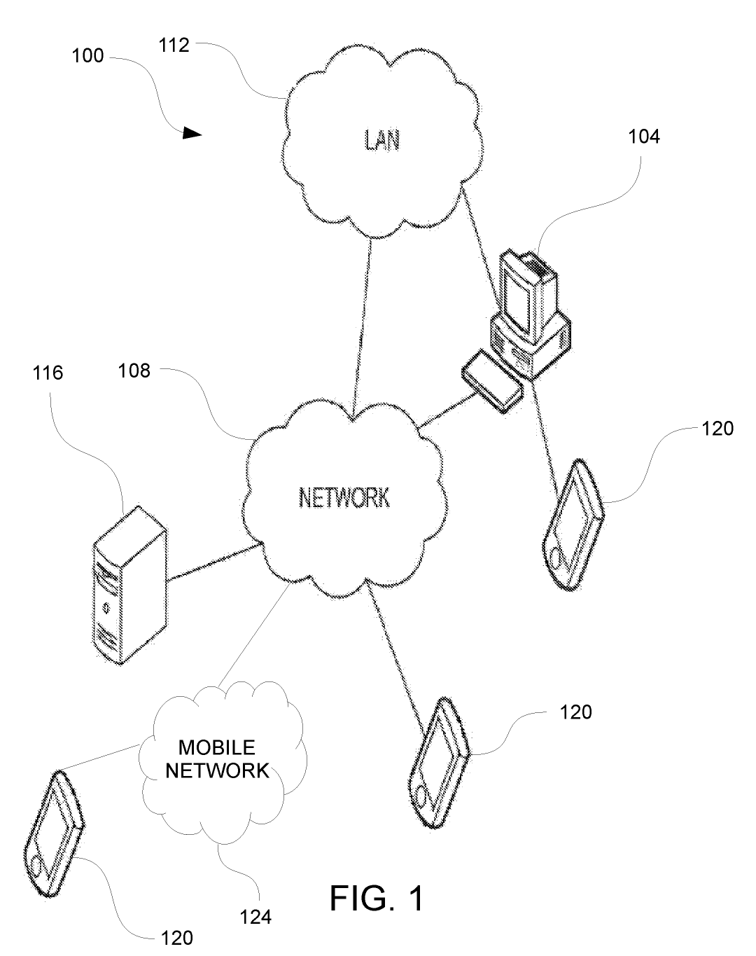

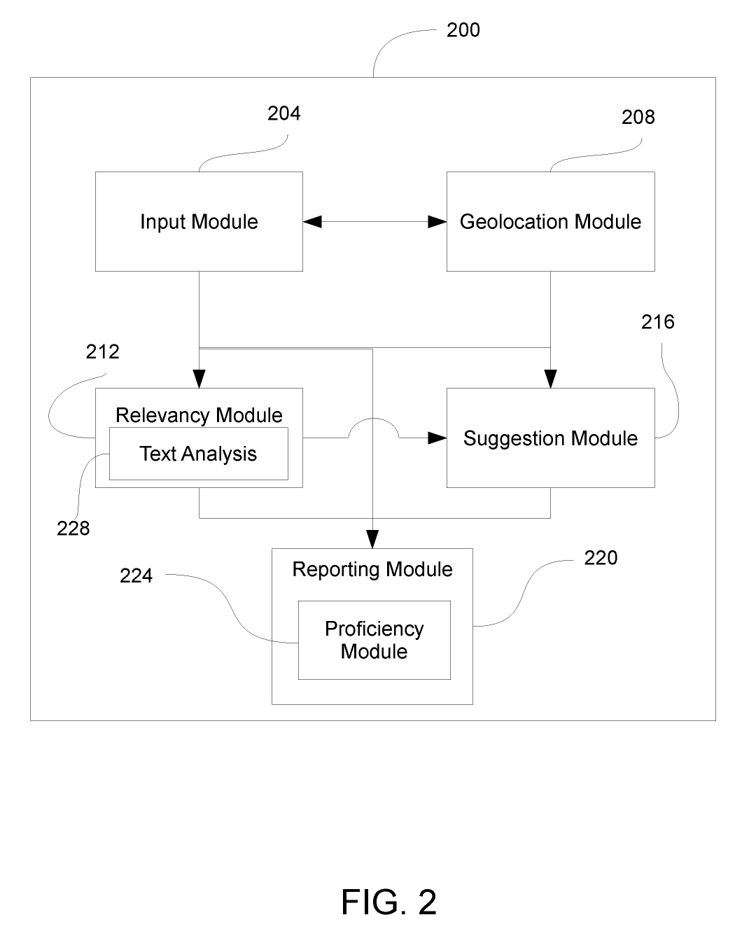

Turning now to the figures, FIG. 1 schematically illustrates an embodiment of a system 100 used to facilitate that operation of an EPD 200 (depicted in FIG. 2 and discussed below). System 100 may be used to communicate a wide variety of information within and external to EPD 200 including, but not limited to, course information, user preferences, user situational factors, including time, date, duration, user location, promotions, or other information and content that can assist in understanding the educational opportunities available to, engaged in, and the level of engagement by the user.

System 100 may include a computing device 104, an information network 108, (such as the Internet), a local area network 112, a content source 116, one or more mobile devices 120 (e.g., smartphones, tablets, augmented reality devices, such as headsets or virtual reality glasses, and other “smart” devices, e.g., watches, glasses), and mobile network 124. Computing device 104 and mobile devices 120 may communicate through information network 108 (and/or local area network 112 and/or mobile network 124) in order to access information in content source 116. Content source 116 can be, for example, a non-transitory machine readable storage medium, a database, and/or a cloud-based server/instance, whether publicly accessible, privately accessible, or accessible through some other arrangement such as subscription that holds educational opportunity information, data, programs, algorithms, or computer code, thereby accessible by computing device 104, mobile devices 120, and EPD 200. Content source 116 can be updated or modified to include new or additional course or instructional information, such as new offerings, updated descriptions, and the like or can be updated by the user. In an exemplary embodiment, certain information contained on content source 116 is not updatable or modifiable except by certain personnel and may only be accessible via a separate computing device 104 that is not available or accessible to the account owner, e.g., a student.

As those skilled in the art will appreciate, computing device 104 may take a variety of forms, including, but not limited to, a web appliance, a laptop computer, a desktop computer, a computer workstation, a terminal computer, web-enabled televisions, media players, and other computing devices in communication with information network 108. EPD 200 may be accessed on or interacted with computing device 104 by, for example, a user performing an overt action with respect to a web-based interface provided through network 108, such as clicking on a map or list or typing in a location so as to indicate the selection of place, experience, or activity. Computing device 104 communicates with one or more components of information network 108, such as, but not limited to, other mobile devices 120, content source 116, and other computing devices.

Information network 108 may be used in connection with system 100 to enable communication between the various elements of the system. For example, as indicated in FIG. 1, information network 108 may be used by computing device 104 to facilitate communication between content source 116 and the computing device, as well as mobile devices 120 and EPD 200. Those skilled in the art will appreciate that computing device 104 may access information network 108 using any of a number of possible technologies including a cellular or mobile network, such as mobile network 124, which can be WiFi (a wireless local area network), wired Internet access, combinations thereof, as well as others not recited, and for any of a number of purposes including, but not limited to, those reasons recited above. In an embodiment, information network 108 and local area network 112 are a unitary network (not shown) as would be the case for a “cloud” based system.

In some situations, the locations where the user may discover or be involved in educational opportunities may be relatively inaccessible by wireless transmissions, e.g., outdoor adventure camps, inside buildings such as, but not limited to, museums. In an exemplary embodiment, one or more of the modules included with EPD 200 (discussed in detail below with reference to FIG. 2) reside on computing device 104 or mobile device 120. This configuration can allow a user to capture the appropriate information and to later upload the relevant data when connected to information network 108. Alternatively, communication between the modules included with EPD 200 may be initiated through a webpage instantiated in a web-based environment accessible through an information network, such as network 108. In this embodiment, if wireless Internet access is available, then the data may be transmitted to a database residing on a server. If wireless Internet access is not available, then the data can be saved locally (e.g., on computing device 104) until such time that wireless Internet access is available and/or the individual attempts to send the saved data or a collection of saved data back to the server.

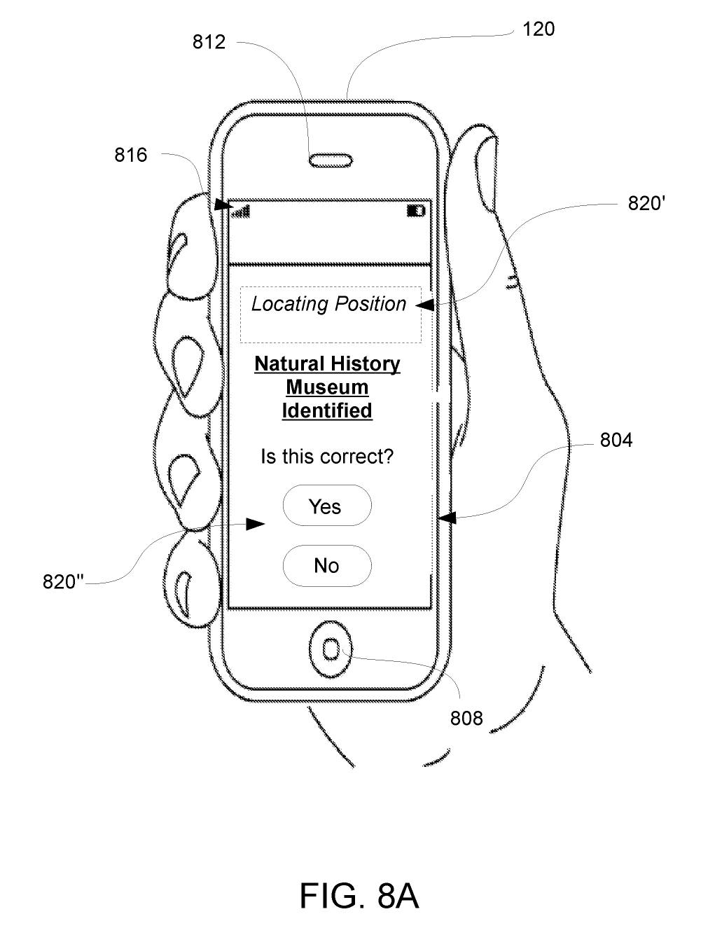

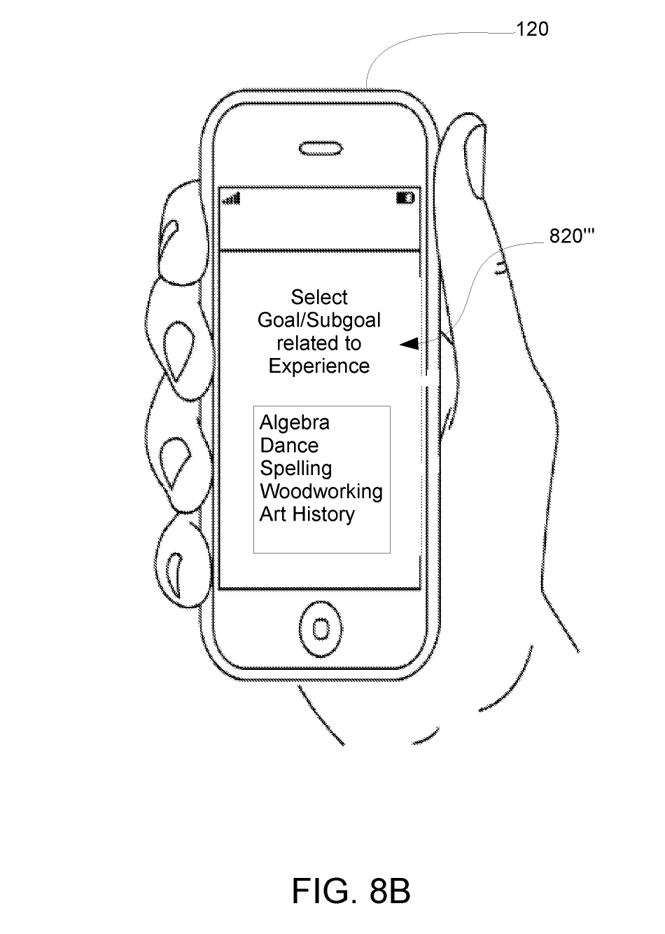

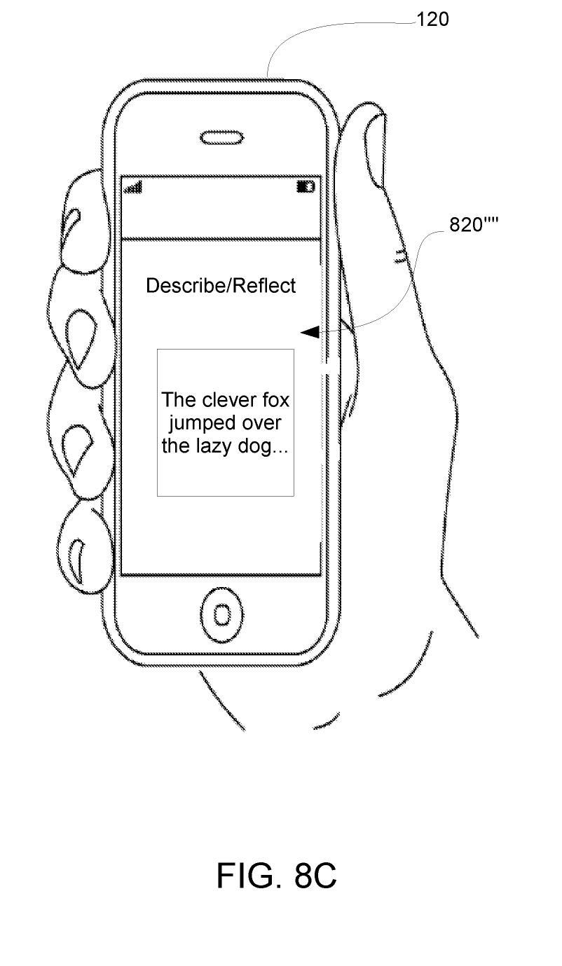

EPD 200 may be accessed or interacted with on mobile device 120 by, for example, a user performing an overt action with respect to a user-interface element (discussed further below with reference to FIGS. 8A-C) on the mobile device, such as touching an element or clicking on an element on the mobile device screen so as to indicate that a place or activity is being selected at the time the overt action is taken. Mobile device 120 may communicate with one or more components of information system 108, such as, but not limited to, other mobile devices 120, content source 116, and one or more computing devices 104. Mobile device 120 may communicate to the aforementioned devices through information network 108, mobile network 124, and/or local area network (LAN) 112, so as to access, record, store, or retrieve information, such as place, user, experience, and/or or relevancy information (discussed in detail below with reference to FIG. 2), in content source 116.

As noted above, EPD 200, at a high level, includes one or more software modules configured to allow user to, among other things, input educational experiences; upload media, such as, but not limited to, documents, spreadsheets, voice files, images, video, augmented reality screen captures; the input of goals, reflections, comments, and assessments by the user or others; an evaluation of the relevancy, timing, and relationship, of inputs and the progress toward one or more goals; notification to interested parties of new activity input by the user; the creation of a dynamic resume; the development of a proficiency metric; and the capability to review, search, research, analyze, and distribute aggregated information related to multiple users. EPD 200 is individual to the user and travels with the user both geographically (to capture learning opportunities outside of the confines of a brick-and-mortar schools) and temporally (a user's profile, goals, proficiencies, etc. stay with them as the user transfers schools, graduates, moves jobs, etc.). To simplify and control the input of experiential information, one or more of the modules included with EPD 200 determines the appropriate relationship of the experiential information to one or more goals based upon the place where the individual is. The location of the place may be any geolocatable position, but is generally associated with the structure, building, land, etc. that has a learning experience available, e.g., museum, cultural event, etc.

In the exemplary embodiment shown in FIG. 2, EPD 200 includes an input module 204, a geolocation module 208, a relevancy module 212, a suggestion module 216, and a reporting module 220. Input module 204 allows for inputting input data, e.g., course information, events, experiential learning opportunities, online experiences, social media conversations, etc., from a user or connected third-party into EPD 200. In this embodiment, when EPD 200 is implemented using computing device 104, which can be, for example, a laptop computer, a desk top computer, a tablet, or other computing device capable of connecting to the Internet, input module 204 permits a user to, among other things, establish a learning plan account; select and update their profile, including, but not limited to, goal setting, educational progress, and experiential timeline; and reflect on and distribute their experiences.

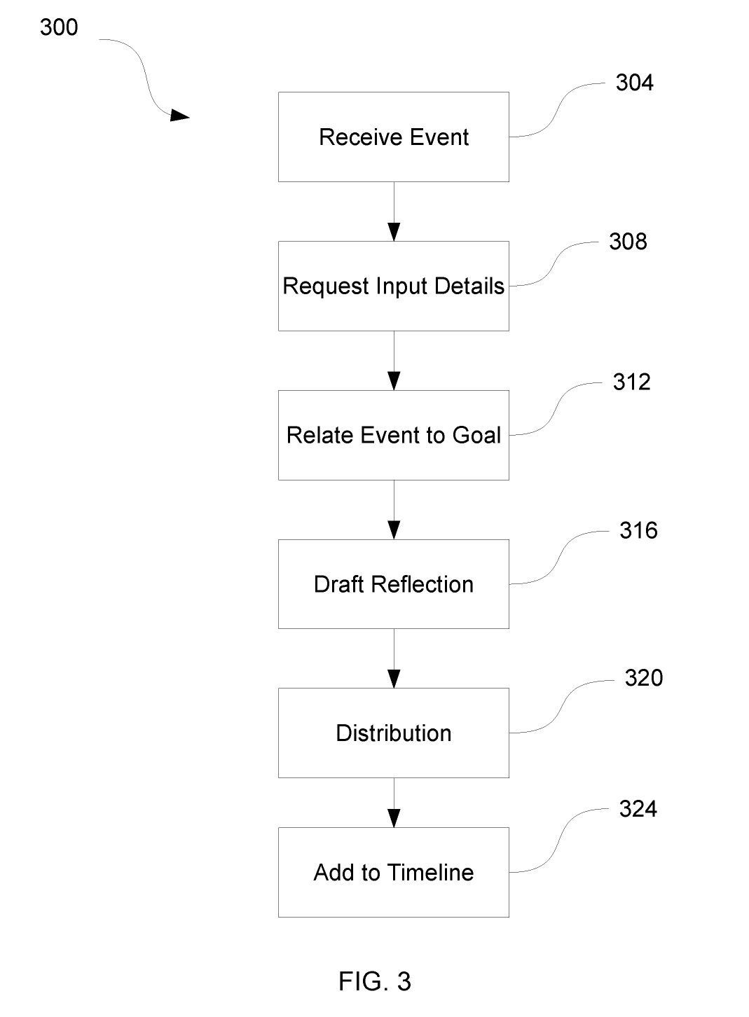

In an exemplary embodiment of input module 204, the input module assists in navigating the user through the inclusion of a new experience or educational event (collectively, “event”) via a process, such as process 300, shown in FIG. 3. For example, and with reference to FIG. 3, input module 204 may receive an event at step 304. Typically the experience or educational event will have some relationship to a goal or objective of the individual. The event can be, among other things, a course assignment, a grade, an online course, a museum visit, a sporting competition, or any other activity or experiential learning event that contributes to a skill or goal pursued by the individual.

At step 308, input module 204 may request pertinent details regarding the event. For example, the individual may be requested to identify the location, duration, date, results, etc. In an alternative embodiment, input module 204 receives some or all of the pertinent details from a third-party source. For example, if the event is an online course, input module 204 can retrieve some or all of the pertinent details of the course, such as, but not limited to, the course title and description, the subject matter of the course, the duration and timing of the course. In another embodiment, the details may be partially or fully automatically populated if input module 204 information related to the event (location, timing, images, etc). In an exemplary embodiment, once an educational course, online course, or similar ongoing event (as opposed to a unique event, such as, but not limited to, a competition) is uploaded, input module 204 can automatically update the individual's profile based upon activities that occur during the course. For example, if an individual is enrolled in an online course that routinely quizzes the individual on materials taught, each quiz may be automatically inserted into the individual's profile.

At step 312, the individual is asked to relate the event to one or more goals or to create a new goal. As discussed in more detail below, the degree to which an event is relevant to and informs as to the proficiency of a skill or goal can be determined using a proficiency module 224. In certain embodiments, the event may be automatically or dynamically related to the goal via, for example, meta-data included with the event, preferences previously received by the user, user tags or other indicators, and/or location information may provide an indication of what goal the event may or should be associated with.

At step 316, the individual is asked to draft a reflection regarding their opinions, feelings, take-aways, etc., regarding the event. Reflections on learning activities are a critical part to the education process as it is informative as to the proficiency gained by the individual. Reflections, in certain embodiments, can improve the relevancy of an event towards the progress of obtaining proficiency toward a given skill or goal. In an exemplary embodiment, reflections by the user may include links or relationships (e.g., tags) to other goals or performance metrics.

At step 320, the individual is asked who, if anyone, should be notified of the addition of the event. Another measure of relevance for certain embodiments of EDS 200 is the input of comments and contributions by others related to the event uploaded by the individual. Typically, the comments and contributions would be by educators, parents, and other stakeholders (collectively, “reviewers”), but generally excludes peers. The exclusion of peers is to focus the individual's attention on educational growth, not on social acclimation or promotion, although an individual may also, in certain embodiments, have the ability to connect with individuals with similar interests so as to allow for collaboration on certain educational activities. In certain embodiments, the distribution may be present or predetermined based upon the goal. For example, the goal of math improvement may be linked automatically to the individual's math teacher so that the individual's math teacher is kept abreast of any events that the student relates to this goal. In certain embodiments, reviewers are able to remove the event from the individual's profile if it is deemed not relevant or does not meet the certain standards (e.g., course standards, etc.).

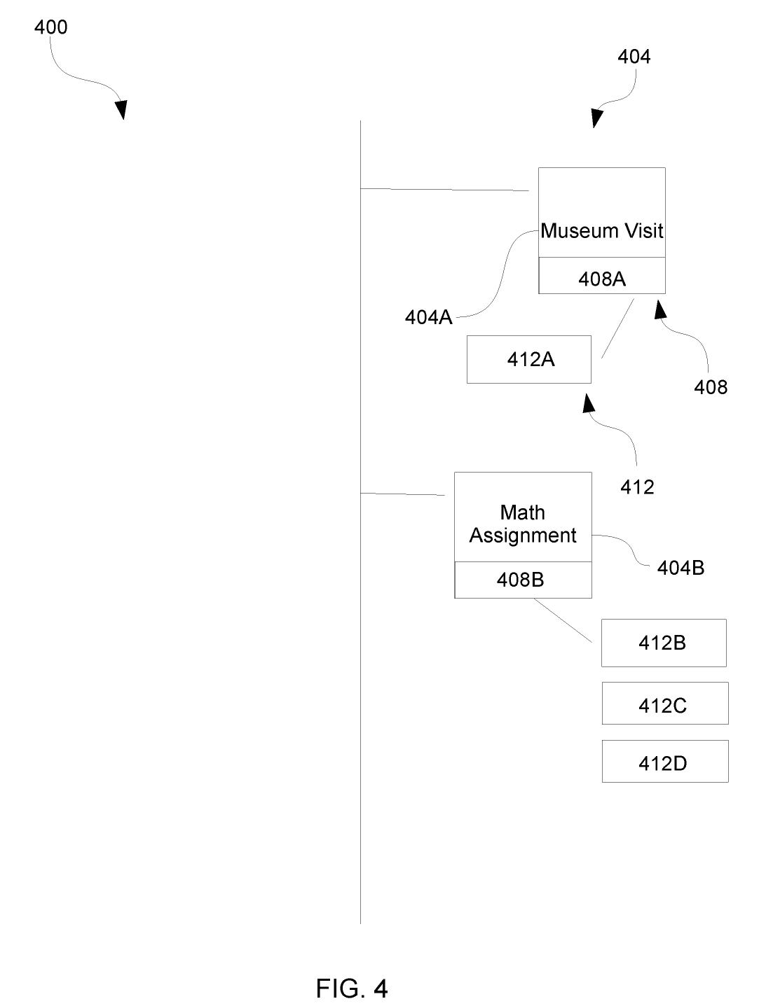

At step 324, the event is added to the individual's timeline. The timeline is a display of information that gives the individual an understanding of their progression toward various goals over time. An exemplary timeline is shown in FIG. 4 and discussed in more detail below.

In another exemplary embodiment of EPD 200 and input module 204, certain ones or all of the activities shown in process 300 are automated thereby facilitating rapid inclusion of new events. For example, input module 204 can, in conjunction with geolocation module 208 (discussed below), use a facilities network (e.g., information network 108) to track the individual while the individual investigates the facility (e.g., a museum) and offer a map of the facility. In this embodiment of the automatic EPD 200 and using the example of an individual entering a museum, input module 204 automatically updates the individual's timeline as she enters a museum or spends a certain amount of time in or around a specific section of the museum. Input module 204, upon recognizing these aforementioned activities, can then present the individual with an opportunity to accept a pre-populated learning opportunity related to one of the individual's stated goal, or offer a new, previously unreported goal. For example, in the specific museum discussion just above, input module 204 may indicate “I see you are enjoying the Metropolitan Museum of Art, would you like to add a new goal of learning about modern art?”) As another example, input module 204 recognizes that the individual entered the Metropolitan Museum of Art, stood the “modern section”, and identifies a picture taken (through known image search technology) by the individual of an Andy Warhol painting. Understandably, any number of smart devices may be configured to interact with EPD 200 so as to provide context and other information related to an event/activity that the user is experiencing/engaged with. With this information, input module 204 can use databases and other sources of information (e.g., content source 116) to prepopulate information related to the event (time, place, date, painting, etc.) and present the individual with information about the painting that can be optionally added to the individual's timeline and be commented on by the individual or other stakeholders.

Another exemplary application and use of EPD 200 is in the job/employment context. For example, EPD 200 can be configured to conduct automated job searches and/or identify training opportunities based upon the individual's stated goals, proficiencies, location, and context relevancy. In this way, EPD 200 could conduct real time job matching based on proficiency at a job fair, conference, or event where the individual can easily view and sort opportunities posted by marketplace participants at that physical event and know where potential employers are, schedule interviews, and/or push out a dynamic resume, such as dynamic resume 500 (discussed below). Marketplace participants at the physical conference would also have the ability to know who is at the conference, review the attendees based upon desired proficiencies, and reach out to a potential applicant using EPD 200.

Timeline 400 shows a plurality of events 404 inputted by an individual, stakeholder, or other entity that is authorized to update the individual's timeline, using, for example, input module 204. Importantly, timeline 400 is configured to organize and display the individual's educational and experiential activities (extracurricular, online, etc.) not other's activities or interests like social media sites, such as, but not limited to, Twitter®, Facebook®, LinkedIn®, etc. Timeline events 404 may each relate to different goals, but is shown sequentially, by date, on timeline 400. As shown in FIG. 4, timeline event 404A is a museum event, which has been linked to a goal 408A (history) and includes a reflection 412A and timeline event 404B is an assignment for a math course, which is linked to a goal 408B (math) and includes a plurality of reflections 412B-D, which represent a conversation about the assignment. Timeline 400 allows for the individual to manage and reflect upon experiences relative to other experiences in the timeline and provides a bases for understanding the proficiency of the individual relative to a goal. Timeline 400 can be collapsed by various criteria, e.g., goal, semester, date, etc., and can be sorted, filtered, or otherwise manipulated to display information for the individual and/or another interested party. For example, if the individual desired to see all activities related to a “Science” goal, the individual could filter their timeline by this goal and the timeline would reflect only those items that have been designated as related to the goal. The individual could then comment or otherwise interact with the filtered timeline. This may be useful if an individual needs to find a specific event, e.g., a science report, and respond to a teacher's comments on the report.

Returning to FIG. 2, input module 204 may also allow the individual to designate a specific geolocatable place as an event, which may be useful for, for example, if the place has multiple building sites or multiple areas (for example, like a large museum) which makes automatic recognition difficult or to indicate a precise location of the educational area and/or the purpose or import of the visit. The individual may select or designate the location using computing device 104 by ways known in the art, such as, but not limited to, touching a spot on a touch screen, voicing a command, directing a trackball, or using other devices in combination with a computer-based map program. For example, an individual may designate the geolocatable place on the map program that is displayed on computing device 104 or portable device 120 by moving an indicator of the program to the location of the place on the map, and registering the geolocation by clicking a mouse button, voicing the appropriate command, pressing the touch screen, or otherwise so indicating his/her present location.

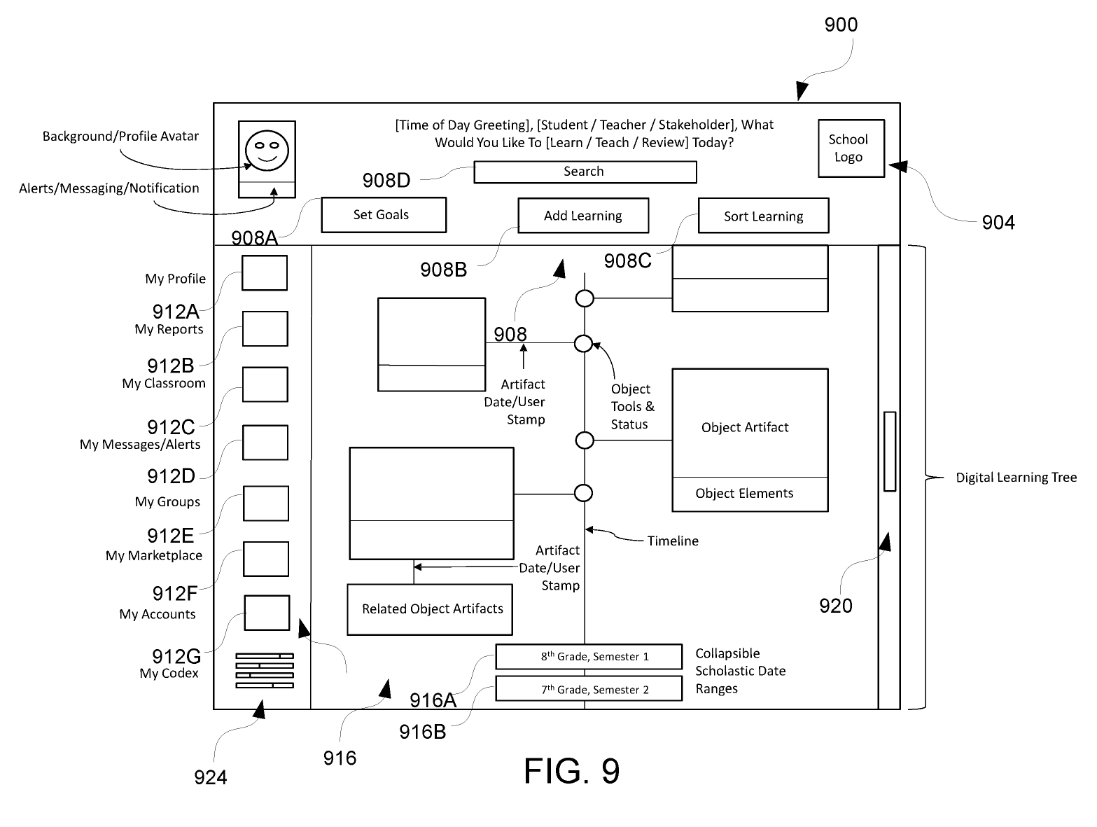

Input module 204 may also allow an individual to include other related information to the geolocatable place/event. For example, an individual can input a time of arrival at the place, an experience the individual had at the place, the type of event occurring at the place, and the like. A person of ordinary skill in the art should understand that some examples of the aforementioned pieces of related information may be generated automatically when the individual designates geolocatable place. For example, if the individual designates a geolocatable place on portable device 120, e.g., by tapping an individual interface element (such as a touch screen displaying a map program) with a command such as “Record This,” the portable device may concomitantly record a time-stamp associated with the designation. The data input by an individual into input module 204 may be stored in a database (described further below with reference to FIG. 9) for later retrieval or processing.

Geolocation module 208, in an exemplary embodiment, is configured to automatically identify the location of the individual, or act upon the request of the individual via input module 204, so as to identify and/or record the location of a place, which in some embodiments may be a pair of coordinates (i.e., latitudinal and longitudinal) representative of a current location of the individual, an address of a business, a building site, or other addressable or geolocatable place. It should be appreciated by those of ordinary skill in the art that location information may be obtained in a number of different ways. For example, location information may be identified using a mapping program, Internet-based or otherwise, IP address of a computer or wireless network, and other known means. In an exemplary embodiment, the location of the device (e.g., mobile device 120) indicates to EPD 200 which site, building, or location the individual is at and the front-end application presents to the individual, based upon his/her location, the options for educational experiences at that time.

In an embodiment, computing device 104 (FIG. 1) includes technology for determining an address of an indicated place or ascertaining information associated with the indicated place using geolocation module 208. Computing device 104 can then communicate that information to another entity, or another entity may retrieve that data from the computing device. When computing device 104 communicates with another device (such as mobile device 120), the computing device is associated with identifying information such as addressing information, presence information, expected experiences at the location, and the like. For example, computing device 104 can become associated with an Internet protocol (IP) address, a MAC address, a network port, or any number of other types of addressing or locating information. IP addresses, MAC addresses, and others may be analyzed to ascertain information about the location of the computing device 104. Alternatively, computing device 104 can utilize an address associated with an Internet service provider, a local area network, and the like. In certain embodiments, geolocation module 208 can identify the location of the individual and concomitantly identify nearby educational opportunities that are related to the individual's goals. For example, if the individual has an interest in military history and the individual is proximate a museum or other artifact, geolocation module, alone or in combination with other modules in EPD 200, can suggest that the individual engage in the experiential opportunity.

EPD 200 can also evaluate the events input by the individual or automatically received via relevancy module 212. In an exemplary embodiment, relevancy module 212 determines the extent to which an event indicates progress toward an individual's goal. For example, if the individual's goal is algebra, relevancy module 212 can determine whether, and how much, an event that is an online course in geometry, relates to the goal. Relevancy module 212 may also be designed and configured to do complex calculations required to determine how impactful a newly added event progresses toward the individual goals and concomitantly how impactful an older event reflects the progress toward the goal. For example, if an individual records a first event that is an algebra test focused on linear equations and scores an 82%, then three weeks later, the individual records a second event that is an algebra test focused on linear equations and scores a 94%, relevancy module 212 would evaluate the improvement of the individual, discounting the impact of the first event and elevating the relevancy of the second event.

Relevancy module 212 can also evaluate entered inputs that, depending on the value and/or timing, can be transmitted to a stakeholder for further action. For example, if an individual's progress toward a goal appears to be lagging, e.g., the individual has failed to input an experience that is attributable to a goal for a certain amount of time or the experiences are duplicative (e.g., test scores are not improving), relevancy module 212 can identify the lack of progress and notify a stakeholder. Alternatively, relevancy module 212 may provide information related to an individual's progress to suggestion module 216 for further evaluation.

In another embodiment, relevancy module 212 may include a text analysis module 228. In an exemplary embodiment, text analysis module 228 evaluates an input and analyzes any text, e.g., reflections, document content, comments, meta-data, to identify text strings that are of value or of limited value (e.g., articles, salutations, names or user IDs) when identifying topics, keywords or similarities between inputs. At a high level, text analysis involves one or more of information retrieval, lexical analysis to study word frequency distributions, pattern recognition, tagging/annotation, information extraction, data mining techniques including link and association analysis, visualization, and predictive analytics. The overarching goal is, essentially, to turn text into data for analysis, via application of natural language processing (NLP) and analytical methods.

High-quality information from the inputs is typically derived through the devising of patterns and trends through means such as statistical pattern learning and evaluation and interpretation of the output. “High quality” refers to some combination of relevance, novelty, and interestingness. The determination of high quality information may occur through text categorization, text clustering, concept/entity extraction, production of granular taxonomies, sentiment analysis, document summarization, and entity relation modeling (i.e., learning relations between named entities). For example, a text string can be identified based on the context of the text string. For example, a text string can be identified as having value or being high-quality when classifying the document by analyzing text near the text string and using various contextual signals (e.g., salutations, letter closings, punctuation, rules to interpret regular expressions and lists of common terms). In addition, the system may refer to meta-data associated with the document, such as date information, the commenter's name, the associated goal, etc., to identify the text string. Information identified by text analysis module 228 can be stored in a database and tagged with a designation as either high-quality or low-quality. Identifying and reducing the use of low-quality information reduces and/or eliminates errors in determining the relevancy of inputs. In an exemplary embodiment, text analysis module 228 can also assist in determining whether, for example, a comment is more positive or more negative as it relates to the input. This information can then be used to evaluate the import of the event toward the individual's goal and concomitantly, their proficiency.

Suggestion module 216 evaluates the data from relevancy module 212 and input module 204 and determines and provides experiential and education opportunities to the individual. Suggestion module 216 may use several factors to determine what to suggest to an individual including, but not limited to or confined by 1) the progress toward a given goal, 2) recent relevant inputs, 3) recognized deficits, 4) recommendations from stakeholders, 5) individual preferences (e.g., low or no cost only recommendations), 6) locale, and 7) relatedness of marketplace opportunities. As an example, if an individual is not showing proficiency in grade 6 algebra, suggestion module 216 can recommend remedial courses or activities that are known or have the potential to improve the proficiency of the student. As another example, if an individual is shown to have advanced algebra 6 proficiencies, suggestion module 216 can recommend more advanced classes and activities, e.g., algebra 7 lessons (even if the remainder of the class is not at the same knowledge/skill level). In an exemplary embodiment, suggestion module 216 can (with or without another module discussed herein) alert a teacher or other interested party about the proficiency/deficiency so that the teacher or other interested party can react as appropriate.

Suggestion module 216 can also analyze the individual's activity information for potential recommendations that would show improved proficiency. For example, an activity, engaged in by the user may have been associated with Goal 1, but, unbeknownst to the individual, the activity also relates to Goal 2. Suggestion module 216 can recommend that the individual link the activity to Goal 2, thereby more completely showing the individual's proficiency as it relates to Goal 2.

The information used by suggestion module 216 can come from a number of sources and databases. For example, and as mentioned above, suggestion module 216 may interact with geolocation module 208 to identify and suggest learning opportunities based upon the individual's location. While geolocation module 208 provides information about the individual's locale, suggestion module 216 may combine this information with other public sources of information, such as business and cultural descriptions, or publicized discounts, specials (e.g., discounted admissions tickets), and offers consistent with known pedagogical and scholastic standards and metrics.

Marketplace opportunities may be suggested to the individual in order to improve their competencies in any given area, goal, or desired skill, or may be suggested based upon a relatedness to previously engaged in opportunities and may be done in real time, e.g., as the individual is engaged in another, related, activity. The marketplace opportunities may be available on the Internet, mobile devices (e.g., apps), and/or virtual reality systems. For example, specific virtual reality programs may be suggested to the individual, which would be credited toward specific goals. Third party online learning tools, such as, but not limited to, edX®, Coursera®, Wikipedia®, Khan Academy®, and YouTube®, can be a part of the marketplace opportunities, as can be suggestions from, stakeholders, affinity groups, instructed uploaded media, and other individual's uploaded media.

After input data is evaluated by relevancy module 212 and suggestion module 216 (when implemented), relevant reports and or notifications may be delivered by reporting module 220. Reporting module 220 may allow for sorting, filtering, and displaying the data, comparisons, data trends, and alternative suggestions, as desired. If notifications are required based upon pre-determined criteria (either required or requested), a notification can be immediately transmitted to the appropriate parties, including, but not limited to, a teacher, a school system, a parent, a stakeholder.

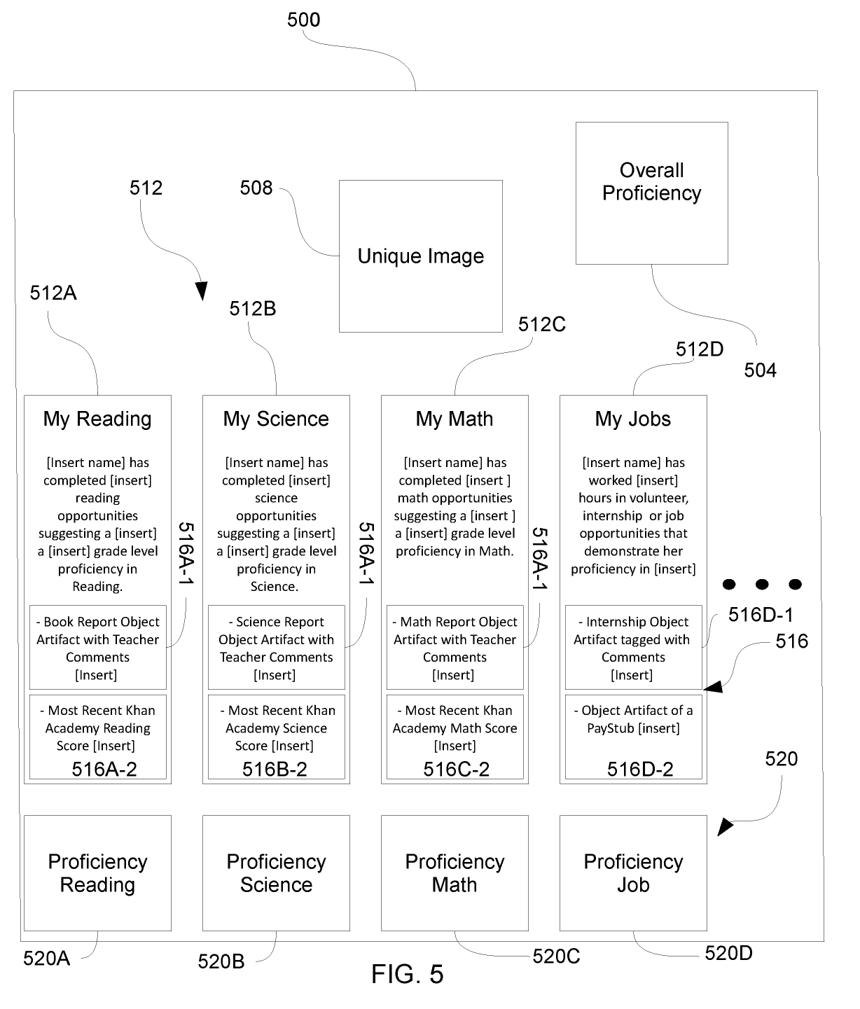

In an exemplary embodiment, reporting module 220 uses various inputs and relevancy information to create a dynamic resume. An exemplary dynamic resume 500 is shown in FIG. 5. At a high level, a dynamic resume is a snap-shot in time of an individuals' accomplishments and progress toward goals and the acquisition of certain skills. As shown in FIG. 5, dynamic resume includes an overall proficiency metric 504, which is an assessment of the individual's combined proficiencies. Typically, although not necessarily, overall proficiency metric 504 is most useful in the context of a student, where the overall proficiency metric would be an alternative and, arguably better, representation of a student's proficiency and capabilities than the student's grade point average. Report 500 can also allow for customizable assets 508, such as a unique image, theme, or other personalized combination of images, colors, etc., that allow the individual to express themselves. Report 500 also includes all or some of an individual's goals 512, such as goals 512A-D, which include, but is not limited to, a selection of experiences that are indicative of progress toward each goal and an assessment of progress toward goals. For example, and as shown in goal 512A, the goal is listed as “My Reading” (reading being the operative goal) and a short description of completed activities and a grade level assessment. Also optionally included are artifacts 516 with corresponding to each goal 512, which are representative events which may or may not include comments or other writings. For example, goal 512A includes artifacts 516A-1 and 516A-2, with artifact 516A-1 being a book report with teacher comments and artifact 516A-2 being the individual's most recent Khan Academy® (an online reading teacher and tester) score. Dynamic resume 500 may also include a goal or subject area proficiency metric 520, e.g., 520A-D, that corresponds to the individual's determined proficiency toward each goal 504. Other items may be included with a dynamic resume, such as dynamic resume 500, and the dynamic resume may be organized according to individual preference or in response to a specific request (scholarship application, job application, admissions application, and the like).

In another exemplary embodiment, a dynamic resume of an individual may also be prepared by a third party, such as, for example, a college admissions officer, in such a way as to allow for identification and comparisons of potential candidates. In this embodiment, the admissions officer may be looking for certain qualities in a potential applicant for, for example, distributing a scholarship. In another exemplary embodiment, reporting module 220 is configured to identify trends across students of a particular teacher, class, school, district, and/or state and to identify opportunities for the district, school, teacher, or class, such as a regional teacher achievement award or to report bulk performance metrics to state boards and supervisory unions.

As used herein, goals for an individual may be a predetermined goal set, such as, on a “country level”, “state level”, or “school level”, and may be referred to as themes/performance indicators/Educational Quality Standards (EQS), and provide the baseline educational metrics for the region in which the individual/student lives and which the teacher/student needs to follow. Goals can also be set by the teacher/school and/or a student can add personal goals related to each of these “EQS” themes, or include related goals. For example, “chemistry” would be an EQS theme for their school, and “learning the periodic table” and “learning about covalent bonds” would be personal goals related to the theme. An unrelated goal could be “to gain greater confidence speaking in public”. If the student gave a chemistry presentation, the student could tag all three goals and a theme/EQS.

In another exemplary embodiment, reporting module 220 can provide information that is filtered against all goals related to desired theme, by region, by school, and/or for a similar demographic, and provide a comparison against an opposing set of information (e.g., another region, school, etc.). In this way, reporting module 220 and proficiency module 224 (discussed in more detail below) can be used to identify factors/events/structures that contribute to proficiency of certain types of individuals.

Reporting module 220 can include a proficiency module 224. At a high level, proficiency module 224 determines the competence (a proficiency metric) of the individual as it relates to a given goal. In an embodiment of EPD 200, a proficiency metric developed by module 224 may accompany a report of generated reporting module 220.

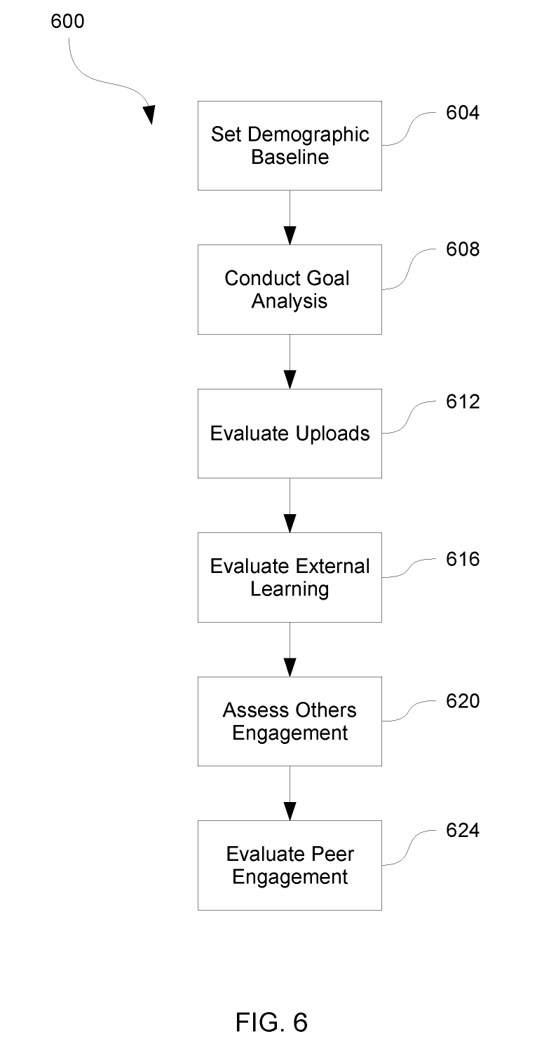

Proficiency module 224 evaluates the inputs of an individual on multiple levels, including, but not limited to, per goal/sub-goal and overall proficiency in a discipline. At a high level, proficiency module 224 can use a process, such as process 600 shown in FIG. 6 in order to determine the individual's proficiency related to a certain goal. Proficiency module 224 can also evaluate an event's temporality, its particular relevance, its effect on aggregated relevance, and the breadth of relevant opportunities/experiences available in developing a proficiency metric for a given goal. Proficiency module 224 would weight multiple ones of the previously mentioned factors, others discussed in process 600, below, or proficiency factors that are determined to be indicators of proficiency as determined by data analysis and feedback by users of EDP 200.

At step 604, a demographic baseline is set. At a high level, the demographic baseline attempts to quantify the current capabilities and attributes of the individual in comparison to a control group. Factors that may be included in determining the demographic baseline include, but are not limited to, the present age of the student, the current academic year of the student, the number of extracurricular goals set, the number of online accounts linked. Step 604 can assess, compare, and determine based upon one or more of the above mentioned factors, among others, how the student is performing relative to an expected performance.

At step 608, a goal analysis is performed, which evaluates the individual's goals and quantitative interactions with the goals. Factors that may be considered by step 608 include, but are not limited to; the number of goals set; the number of goals in use in a timeline over a relative period; the number of goals tagged to a timeline artifact (e.g., to learn more about periodic table); the number of new goals added over a given period and their use; the type of goals that were tagged over the period (e.g., state EQS vs. related personal goal vs. unrelated personal goal); whether a goal is below, equal, or above the grade level subject matter for that age, grade group, school (e.g., a 6th grade student posting an 8th grade EQS goal would be given greater weight than a 6th grade student posting a 5th grade EQS goal); and the number of goals within a state level educational metric, theme or EQS (e.g., under state EQS for “Chemistry” student has four related personal goals (periodic table, covalent bonds, etc..) vs. another student who has none).

At step 612, uploads (comments, images, documents, etc.) by the individual and others are evaluated to ascertain the progress toward goals. Factors that may be evaluated in assessing uploads (also referred to herein as posts or artifacts) include, but are not limited to; the number of uploads over a period of time; the number of “complete” uploads (a complete upload is generally considered an upload that has been tagged with a goal and includes, at least, a completed reflection); the number of uploads that include teacher/supervisor comments; and any quantitative scoring or grading associated with an upload/artifact, e.g., quiz or test. In certain embodiments of step 612, the period of evaluation is dependent upon the kind of individual being evaluated (e.g., the assessment period is shorter for a high school student vs. an elementary school student because the high school student is presumed to be involved in more activities).

At step 616, the individual's external learning is evaluated. The degree to which external learning impacts an individual's proficiency as it relates to a given goal can be determined by evaluating, among other things; the number of learning tools activated and lessons uploaded to timeline (e.g., a science lesson from Khan Academy®) the completeness of a specific learning tool upload to the timeline (e.g., lesson and quiz vs. just a lesson); the number of searches performed that relate to a specific goal through a EPD system, such as EPD 200; and the number of investigations emanating from the search results (e.g., clicks on 4 of the 10 online search results provided).

At step 620, engagement by others in the individual's timeline is assessed. The degree to which engagement by others impacts an individual's proficiency as it relates to a given goal can be determined by evaluating, among other things; the number of comments; the number of comments from a teacher/instructor/supervisor; the quality of comments and recommendations, via, for example, textual analysis of positive vs. negative lexicons; and the quality of student posts/reflection/uploaded documents, via, for example, textual analysis of positive vs. negative lexicons.

At step 624, peer engagement with the individual's personal learning plan is evaluated. The evaluation can include, but is not limited to, an assessment of; the number of student rated PLP; the quality of the student ratings; the number of affinity groups (e.g., groups having substantially similar goals) joined; the frequency of comments posted by the individual; and the quality of posting in the groups, via, for example, an examination of the number of words in the comment and the quality of comment, via, for example, textual analysis of positive vs. negative lexicons.

In practice, proficiency module 224 returns a level of proficiency that quantifies student achievement in such a way that it reveals much more about the competency and capabilities of the individual than simple grading alone or standardized testing. Proficiency module 224 can, in certain embodiments, provide a proficiency metric for each goal that an individual has as a part of their personal learning plan, and consistently update the individual's proficiency as the individual engages and progresses toward the goal. In an embodiment, this may be done by using a process, such as process 600, without including step 608, and instead keeping the analysis centered on a single goal.

Proficiency module 224 can also extend the analysis to provide educators and other interested individuals with the data to conduct comprehensive analyses of teacher, school system, state, and federal performance, while still allowing for a level of granularity heretofore unseen as the stakeholders can trace the activity or collective activities that have the biggest impact on proficiency for certain types of individuals.

In certain embodiments, proficiency module 224 can include a blockchain, or other publicly viewable ledger that records every transaction without the possibility of forgery. The advantage of this embodiment is that a diploma, certificate, or even a stated proficiency can be forged or manipulated, and there have been many instances of such fraud in the past. Proficiency module 224 can serve society, not just in preventing fraud, but in reducing the financial barriers, and the discriminatory entry process that currently restricts higher learning only to the moneyed elite, by creating a codex (a proficiency index) that can be indexed against particular goals and an individual's learning plan/experiences that can be independently verified. Proficiency module 224 can certify each entry through verification processes (teacher, class, district), which could provide a permanent and irrefutable record of the individual's qualification for a certain job, school, task, etc. Thus, an individual wouldn't need to attend a class on a subject and incur additional debt if their proficiency in the subject area was already sufficient for the desired task.

In certain embodiments of EPD 200, based upon proficiency module 224, individuals can be identified, by the EPD (by, for example, suggestion module 220) for advanced placement or remedial instruction on an ongoing basis. In this way, EPD 200 is a tool that assists in developing each student's individualized learning plan—not based entirely on what the student wishes to achieve or feels they need—but, instead, based upon an understood proficiency as it relates to specific goals. Thus, an individual whose proficiency is advancing at an accelerated rate can be exposed to additional learning opportunities and given new challenges so as to foster further advancement, while an individual that is struggling at a given discipline can be identified, the structure of their learning plan altered to attempt to correct deficiencies, and the individual's progress continually measured so as to ensure that the desired outcome is being achieved. The personal learning plan developed by EPD 200 is particular to the individual and continuously and dynamically evolving to match the individual's current needs. In certain embodiments, EPD 200 may also alert stakeholders if an individual is simply too far ahead or continues to struggle so that the individual can be assessed for possible alternative experiences.

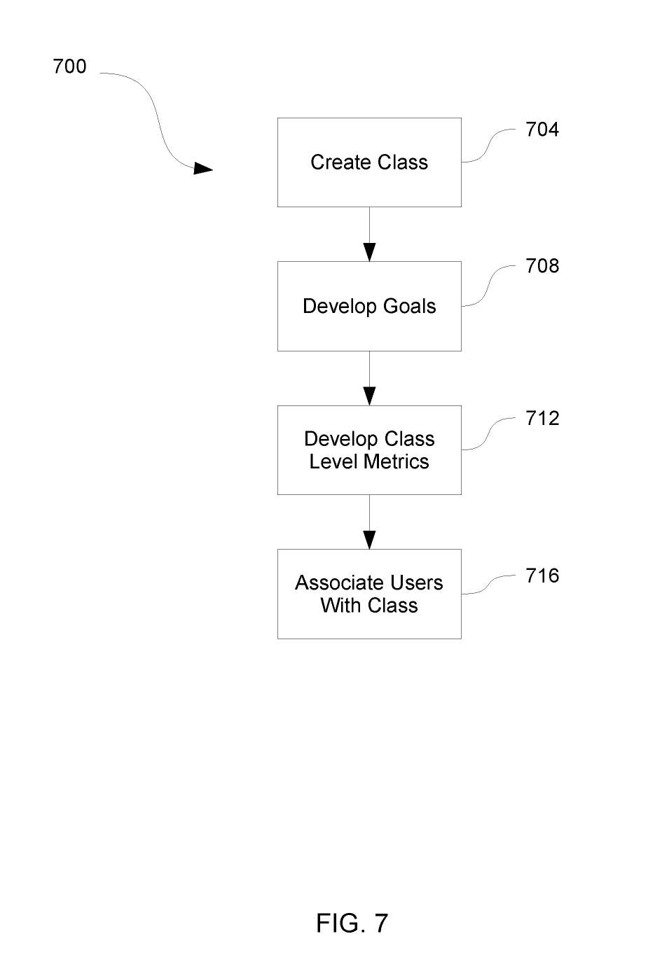

Although goals and objectives can be set by the user, in certain embodiments, the goals and objectives may be set up as part of a process, such as process 700 shown in FIG. 7. As shown, a user or other party that can access EPD 200, for example, a teacher, student, advisor, community member, etc., can create a “class” at step 704. In this context, the term “class” is meant in its broadest sense—it could be a scholastic course offering, a job, a creative performance, a sport, a class project, or most any other type of activity that has one or more goals that can be attributable to it.

At step 708, one or more goals are developed for the class. Typically these goals would have a reasonable relationship to the class. For example, if the class was a community play, a goal developed for this class may be public speaking.

At step 712, proficiency metrics are established for each goal. These proficiency metrics are established so as to provide the user of EPD 200 with fixed criteria with which to strive to obtain through their activities—in other words, the user participates in activities that will improve their proficiency related to the goal and the user can be said to have obtained the goal when the user's proficiency is equal to or greater than the proficiency metric established for the goal.

At step 716, the user who set up the class can identify users of the EPD to ask to join the class. The potential users may be identified by similar traits, goals, region, district, school, teacher, etc.

An interesting aspect of process 700 is that is available to more or less any user of the EPD system. Thus, each user can be a “teacher” and run a “class”, which can be a powerful tool for peer-to-peer learning opportunities.

Turning now to FIGS. 8A-C, there is shown an implementation of a mobile device 120 (FIG. 1) suitable for use with EPD 200. Mobile device 120 can include a touch-sensitive display 804, an input device 808, a speaker 812, and a transceiver 816. Touch-sensitive display 804 is sometimes called a “touch screen” for convenience, and may also be known as or called a touch-sensitive display system. Touch screen 804 can be used to display information or to provide individual-interface objects 820 (e.g., virtual (also called “soft”) control keys, such as buttons or keyboards), thereby providing an input interface and an output interface between mobile device 120 and an individual. Information displayed by touch screen 804 can include graphics, maps, text, icons, video, and any combination thereof (collectively termed “graphics”). In an embodiment, and in use with EPD 200, an individual can select one or more individual-interface objects 820, e.g., object 820′, using touch screen 804 to designate that mobile device 120 is at the appropriate location.

Touch screen 804 has a touch-sensitive surface, which uses a sensor or set of sensors to accept input from the individual based on haptic and/or tactile contact. Touch screen 804 may use LCD (liquid crystal display) technology, or LPD (light emitting polymer display) technology, although other display technologies may be used in other embodiments. Touch screen 804 can detect contact (and any movement or breaking of the contact) on the touch screen and converts the detected contact into interaction with individual-interface objects (e.g., one or more soft keys, icons, web pages or images) that are displayed on the touch screen. Touch screen 804 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 804. In an exemplary embodiment of the use of mobile device 120, an individual presses a finger to touch screen 804 so as to initiate contact. In alternative embodiments, an individual may make contact with touch screen 804 using any suitable object, such as, but not limited to, a stylus.

Input device 808 facilitates navigation among and interacts with one or more individual-interface objects 820 displayed in the touch screen 804. In an embodiment, input device 808 is a click wheel that can be rotated or moved such that it can be used to select one or more user-interface objects 820 displayed on touch screen 804. In an alternative embodiment, input device 808 can be a virtual click wheel, which may be either an opaque or semitransparent object that appears and disappears on the touch screen display in response to individual interaction with mobile device 120.

Transceiver 816 receives and sends signals from mobile device 120. In an embodiment of mobile device 120, transceiver 816 sends and receives radio frequency signals through one or more communications networks, such as network 108 (FIG. 1), and/or other computing devices, such as computing device 104. Transceiver 816 may be combined with well-known circuitry for performing these functions, including, but not limited to, an antenna system, one or more amplifiers, a tuner, one or more oscillators, a digital signal processor, a CODEC chipset, a subscriber identity module (SIM) card, and a memory. As mentioned above, transceiver 816 may communicate with one or more networks, such as the Internet, also referred to as the World Wide Web (WWW), an intranet and/or a wireless network, such as a cellular telephone network, a wireless local area network (LAN), and/or a metropolitan area network (MAN), and other devices. Mobile device 120 may use any of a plurality of communications standards to communicate to networks or other devices with transceiver 816. Communications standards, protocols and technologies for communicating include, but are not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth®, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol.

Transceiver 816 may also be configured to assist mobile device 120 in determining its current location. For example, geolocation module 208 (FIG. 2) can direct transceiver 816 to provide signals that are suitable for determining the location of mobile device 120, as discussed in detail above. As shown in FIG. 8A, mobile device 120 can indicate that it is searching for the current location and relevant experiential information (e.g., interface object 820′). Mobile device can also request input from the individual as to whether or not it has identified the correct location at interface object 820″. The individual can then indicate, using touch-screen 804 or other means, such as voice activation, that the geolocation module 208 has identified the appropriate location.

Mobile device 120 may also include other applications or programs such as, but not limited to, word processing applications, JAVA-enabled applications, encryption, digital rights management, voice recognition, voice replication, and a browser module. The browser module may be used to browse the Internet, including searching, linking to, receiving, and displaying web pages or portions thereof, as well as attachments and other files linked to web pages.

It should be appreciated that the mobile device 120 is only one example of the mobile device that may be used with the present system and method, and that the mobile device may have more or fewer components than mentioned, may combine two or more components, or a may have a different configuration or arrangement of the components. In the present system and method, mobile device 120 may be implemented with any computing device that includes geolocation functionality and is not so large that it is very inconvenient to move it from one location to another. Thus, mobile device 120 is not restricted to a smartphone or other hand-held device, and may include pad or tablet computing devices, smart books, net books, laptops, watches, and even larger computing devices with geolocation functionality that may be moved from one location to another without significant inconvenience.

FIG. 8B shows an illustration of a mobile device 120 displaying another interface object 820, input request 820′. Input request 820′″ can take the form of a drop down menu that provides the previously entered goals/sub-goals of the individual. In another embodiment, input request 820′″ may recommend a goal based upon the location/experience selected by or presented to the individual.

Turning now to a discussion of an exemplary EPD, such as EPD 200, in use and certain use cases, and particularly with reference to FIG. 9, there is shown an exemplary user interface 900. As shown in FIG. 9, an individual can upload and/or organize a number of customizable attributes 904. Customizable attributes 904 include, but are not limited, to, a background, a photo, a logo, an alert, and a greeting. User interface 900 can also include a plurality of interface items 908, which, as shown in FIG. 9, include a “Set Goals” soft button 908A, an “Add Learning” soft button 908B, a “Sort Learning” soft button 908C, and a “Search” soft button 908D. Each of these soft buttons allows the individual to interface with an input module, such as input module 204. On the left side of user interface 900 can be a plurality of advance tabs 912. Advance tabs 912 allow the individual to engage with different resources, such as, My Marketplace 912F, or other groups, such as, My Classroom 912C or My Groups 912D, or other account management aspects, such as, My Accounts 912G. Additional advance tabs 912 may be removed or added by the individual or automatically based upon use by the individual. A timeline 916 is provided with user interface as well and is similar to timeline 400 discussed above. As discussed above but not shown, timeline can be collapsed by various criteria. In user interface 900, timelines 916 is collapsed by semester at blocks 916A and 916B. On the far left of user interface 900, a digital learning tree 920 is provided. On the lower right side of user interface 900 is a proficiency metric 924. As shown, in this embodiment, proficiency metric 924 is a series of horizontal bars with each bar representing proficiency toward a different goal and can show the gap between expected and actual proficiency (right side of bar). Each bar of proficiency metric 924 can be interfaced with, such that the individual can select a bar and the user interface can be arranged and filtered to only show those events and activities related to the goal (as discussed elsewhere herein).

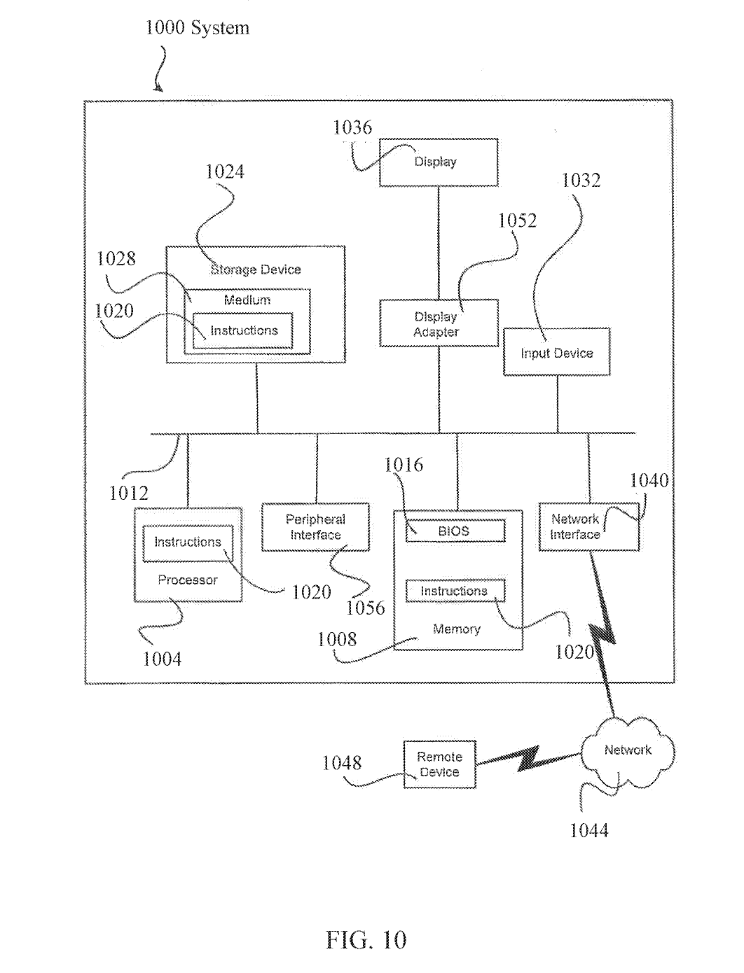

FIG. 10 shows a diagrammatic representation of one embodiment of computing system in the exemplary form of a system 1000, e.g., computing device 104 or mobile device 120, within which a set of instructions for causing a processor 1004 to perform any one or more of the aspects and/or methodologies, such as process 300, of the present disclosure. It is also contemplated that multiple computing devices, such as computing device 104, or mobile devices 120, or combinations of computing devices and mobile devices, may be utilized to implement a specially configured set of instructions for causing EPD 200 to perform any one or more of the aspects and/or methodologies of the present disclosure.

System 1000 can also include a memory 1008 that communicates with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Memory 1008 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 1016 (BIOS), including basic routines that help to transfer information between elements within system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

System 1000 may also include a storage device 1024, such as, but not limited to, the machine readable storage medium described above. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for system 1000. In one example, software 1020 may reside, completely or partially, within machine-readable medium 1028. In another example, software 1020 may reside, completely or partially, within processor 1004.

System 1000 may also include an input device 1032. In one example, a user of system 1000 may enter commands and/or other information into system 1000, for example using input device 208, via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touch screen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to system 1000 via storage device 1024 (e.g., a removable disk drive, a flash drive, etc.) and/or network interface device 1040. A network interface device, such as network interface device 1040 may be utilized for connecting system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network, a telephone network, a data network associated with a telephone/voice provider, a direct connection between two computing devices, and any combinations thereof. A network, such as network 1044, may employ a wired and/or a wireless mode of communication. In general, any network topology may be used. Information (e.g., data, software 1020, etc.) may be communicated to and/or from system 1000 via network interface device 1040.

System 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. In addition to a display device, a system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method comprising:
by one or more computing devices:
receiving an activity associated with a user goal, wherein the user goal has a proficiency metric;
evaluating the relevancy of the activity, the relevancy being a function of the timing of the activity and the relationship of the activity to the one or more user goals; and
developing an updated proficiency metric based upon the evaluating.

2. A computer-implemented method according to claim 1, wherein the proficiency metric is a quantifier of a user competency as the user competency relates to the user goal.

3. A computer-implemented method according to claim 2, wherein the proficiency metric is based, at least in part, upon a comparison to a demographic baseline.

4. The computer-implemented method according to claim 1, wherein the receiving an activity is a function of a location of the user.

5. The computer-implemented method according to claim 1, wherein the receiving an activity includes geolocating the user.

6. The computer-implemented method according to claim 5, wherein the receiving the activity includes receiving activity information based upon the geolocating of the user.

7. A computer-implemented method according to claim 1, further including aggregating the activity into a user timeline, the user timeline including a prior event.

8. The computer-implemented method according to claim 7, wherein the user timeline is filterable by a user selection.

9. The computer-implemented method according to claim 7, further including generating a dynamic resume based upon the updated proficiency metric, the user goal, and the user timeline.

10. The computer-implemented method according to claim 1, further including suggesting another activity based upon the activity.

11. The computer-implemented method according to claim 10, wherein the another activity is a virtual reality learning activity.

12. The computer-implemented method according to claim 1, further including suggesting another activity based upon the updated proficiency metric.

13. The computer-implemented method according to claim 1, wherein another user goal is established, in the first instance, as a function of the activity.

14. The computer-implemented method according to claim 1, wherein the activity is a sport activity, a competition, or a visit to a cultural site.

15. An educational proficiency development (EPD) system for a user, the EPD system comprising:
a portable device having a processor and a non-transitory computer readable medium in communication with the processor, wherein the non-transitory computer readable medium includes:
an input module configured to:
determine a location of the portable device and an activity related to the location, wherein the activity relates to a user goal; and
receive data representing one or more artifacts that are related to the activity; and
a relevancy module configured to determine a user's progress toward a proficiency of the user goal based upon the activity and the one or more artifacts.

16. An EPD system according to claim, wherein the proficiency is a quantifier of user competency as the competency relates to the user goal.

17. An EPD system according to claim 16, wherein the proficiency is based, at least in part, upon a comparison to a demographic baseline.

18. An EPD system according to claim 15, wherein the relevancy module updates the proficiency based upon the activity and the one or more artifacts.

19. An EPD system according to claim 18, further including generating a dynamic resume based upon the updated proficiency metric and the user goal.

20. An EPD system according to claim 18, further including a suggestion module configured to suggest another activity based upon the updated proficiency metric.

21. An EPD system according to claim 20, wherein the suggestion module is configured to identify a deficiency in the proficiency.

22. An EPD system according to claim 21, wherein the suggestion module compares the user's proficiency to a baseline proficiency so as to identify the deficiency.

23. An EPD system according to claim 22, wherein the suggestion module is configured to identify an activity or activities to address the deficiency.

24. An EPD system according to claim 18, further including a suggestion module configured to suggest an another activity based upon the activity.

25. The computer-implemented method according to claim 24, wherein the another activity is a virtual reality learning activity.

26. An EPD System according to claim 15, further including a suggestion module configured to determine and suggest, based upon the user's progress toward a proficiency, a next activity.

27. An EPD system according to claim 15, further including aggregating the activity and artifacts into a timeline.

28. An EPD system according to claim 27, wherein the timeline is configured to be filterable by a user selection.

29. One or more computer-readable non-transitory storage media embodying software configured when executed to:
receive an activity associated with a user goal, wherein the user goal has a proficiency metric, wherein the proficiency metric is a quantifier of user competency as the competency relates to the user goal;
evaluate the relevancy of the activity, the relevancy being a function of the timing of the activity and the relationship of the activity to the one or more user goals;
aggregate the activity into a user timeline, the user timeline including a prior event;
develop an updated proficiency metric based upon the evaluating.

30. A computer-implemented method according to claim 29, wherein the proficiency metric is based, at least in part, upon a comparison to a demographic baseline.

31. The computer-implemented method according to claim 29, wherein the receiving an activity is a function of a location of the user.

32. The computer-implemented method according to claim 29, wherein the receiving an activity includes geolocating of the user.

33. The computer-implemented method according to claim 32, wherein the receiving the activity includes receiving activity information based upon the geolocating of the user.

34. The computer-implemented method according to claim 29, wherein the user timeline is filterable by the goal.

35. The computer-implemented method according to claim 29, further including generating a dynamic resume based upon the updated proficiency metric, the user goal, and the user timeline.

36. The computer-implemented method according to claim 29, further including suggesting another activity based upon the updated proficiency metric and the activity.

37. The computer-implemented method according to claim 29, wherein another user goal is established, in the first instance, as a function of the activity.

38. The computer-implemented method according to claim 29, wherein the activity is a sport activity, a competition, or a visit to a cultural site.
